(19) United States
(12) Patent Application Publication
(10) Pub. No.: US 2026/0192142 A1
(43) Pub. Date: Jul. 9, 2026

(54) FIRE SUPPRESSION DEVICE AND METHOD OF USE THEREOF

(71) Applicant: Christopher Smith, Yucaipa, CA (US)

(72) Inventor: Christopher Smith, Yucaipa, CA (US)

(21) Appl. No.: 19/122,638

(22) PCT Filed: Oct. 25, 2023
(86) PCT No.: PCT/US2023/035912

§ 371 Date: Apr. 18, 2025

Related U.S. Application Data
(63) Continuation of application No. 18/158,797, filed on Jan. 24, 2023, now abandoned.
(60) Provisional application No. 63/420,172, filed on Oct. 28, 2022.

(51) Int. Cl. A62C 5/02; A62C 3/02; A62C 37/36; A62C 37/40

(52) U.S. Cl. CPC A62C 5/022; A62C 3/0214; A62C 37/40; A62C 37/04

(57) ABSTRACT

A fire suppression device can prohibit fire and prevent the same from spreading. The device is compact and is configured to autonomously release type A or type B fire-retardant foam for covering a structure such as a building or portions thereof. The device includes a plurality of components, including a water reservoir, a foam concentrate reservoir, an air reservoir, and an aerator for forming fire-retardant foam. In one embodiment, the device includes a sensor for detecting excessive temperature, smoke, or fire for autonomously actuating the device. In another embodiment, the device is manually activated by a user. The device can be used with new or existing buildings, designated fire (i.e., fireplace) spaces, cook areas and the like.

### CROSS-REFERENCE TO RELATED APPLICATIONS

This application claims priority to U.S. patent application Ser. No. 18/158,797, filed Jan. 24, 2023, and to U.S. provisional patent application No. 63/420,172, filed Oct. 28, 2022, the contents of each of which are herein incorporated by reference.

### BACKGROUND OF THE INVENTION

### 1. Field of the Invention

The present invention relates generally to the field of fire extinguishers. More specifically, the present invention relates to a novel fire suppression device configured to autonomously release fire-retardant foam for preventing and suppressing fire. The device is autonomously activated or actuated upon detecting very high temperature, fire, or smoke for forming and releasing fire-retardant foam. The device can be used in homes and businesses and can also be used for wild (i.e., brush) fires. The device may come in a variety of designs and structures to effectively suppress fire. Accordingly, the present disclosure makes specific reference thereto. Nevertheless, it is to be appreciated that aspects of the present invention are also equally applicable to other like applications, devices, and methods of manufacture.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

By way of background, housefires are common across the globe and when fires burn down homes and businesses, they cause significant economic losses, also referred to as property damage. In fact, in 2020, home fires across the U.S. resulted in an estimated $7.3 billion in direct property damage. Causes of housefires include unattended cooking, grease fires, short circuits due to faulty wiring, candles, holiday decorations/lighting, unattended fireplaces, and more. Space heaters used in homes and businesses may also cause fire when items susceptible to easily catch fire including curtains, laundry, blankets, and furniture are kept near, or come into contact with, the space heaters.

Firepits, campfires, or cooking areas/grills are commonly utilized by humans. Human-caused fires result from unattended firepits, campfires, outdoor cooking elements, burning of debris, equipment use and malfunctions, negligently discarded cigarettes, fireworks, and intentional acts of arson. Lightning is one of the two natural causes of fires.

For preventing fires in homes, structures, and businesses, individuals install smoke alarms for raising an alarm when smoke or fire is detected. Individuals also try to be careful while smoking, keep combustible things away from walls and corners, and more. The most common method of extinguishing a fire is use of a garden hose or small fire extinguisher. However, conventional fire extinguishers require a person to manually activate and operate them. Many times, individuals may be unaware of the fire, which can cause delay in use of such extinguishers. In many scenarios, individuals do not have knowledge of how to operate fire extinguishers. Individuals desire a device other than conventional fire extinguishers for enabling them to easily extinguish a structure fire or prohibit same from spreading.

Firepit or designated fire/cook areas are also left without effective efforts or devices for extinguishing by individuals due to lack of effective fire extinguishing products. Individuals desire an improved device for extinguishing fires that spread from designated fire/cook areas.

Therefore, there exists a long-felt need in the art for a device that enables a homeowner to protect their home from fire. There is also a long-felt need in the art for an improved fire extinguishing device that can be used instead of conventional fire extinguishers. Additionally, there is a long-felt need in the art for a fire suppression device that does not require a user to manually activate and operate the device for extinguishing fire. Moreover, there is a long-felt need in the art for a fire suppression device that autonomously protects a home or structure (or portions thereof) from catching on fire. Further, there is a long-felt need in the art for a fire suppression device that reduces losses caused due to house fires and structure fires. Finally, there is a long-felt need in the art for a fire suppression device that autonomously prevents fire in the area around a home or structure and does not require physical presence of a user for operating the device.

### SUMMARY OF THE INVENTION

The subject matter disclosed and claimed herein, in one embodiment thereof, comprises a fire suppression device. The device is designed to be installed on the roof or outside of a home or a building and is configured to be autonomously activated or actuated when a threshold amount of heat, smoke, or fire is detected by an integrated sensor. The device includes a water reservoir, such as a distilled water reservoir, for holding water, a foam concentrate reservoir for holding a foam concentrate, an air reservoir for holding air, wherein an aerator receives water mixed with foam concentrate and air for aeration to produce high pressure fire-retardant foam, the fire-retardant foam is autonomously released through an outlet pipe or discharge opening for releasing the foam outside to cover the home or building, or a designated portion thereof, to suppress fire. In one embodiment, the device is manually activated using a push button for releasing the fire-retardant foam.

In this manner, the fire suppression device of the present invention accomplishes all of the forgoing objectives and provides users with a device that can be installed on the roof and around building of a home or business for detecting heat, smoke, or fire to release a fire-retardant foam. The device autonomously protects a building or structure from catching on fire (or prohibits spreading of same) and thus prevents financial damage. The water and fire-retardant foam producing chemical can be refilled in the device for reusability of the device.

In yet another embodiment, the device has a multi-purpose sensor for detecting the threshold amount of heat, smoke, or fire for autonomously activating the device to produce and release fire-retardant foam.

In yet another embodiment, the foam concentrate can be used for forming Type A foam or Type B foam and the foam concentrate is introduced to the water for forming the fire-retardant foam.

In yet another embodiment, the counter device is weatherproof and has IP68 rating.

The subject matter disclosed and claimed herein, in one embodiment thereof, comprises a fire suppression shield device. The device further comprising a housing including a plurality of chambers, each chamber is configured to store an internal component for forming a fire-retardant foam, the components include a water reservoir for holding a store of distilled water, a foam concentrate reservoir for holding a store of foam concentrate, an air reservoir for holding a store or air, an aerator motor for forming high pressure foam from the water, foam concentrate and air wherein the aerator motor is autonomously activated upon a safety sensor detecting high temperature, smoke, or fire. The fire-retardant foam generated by the device is released using an outlet pipe or discharge opening for covering a building, or designated room/area, to suppress the fire.

In yet another embodiment, a method of suppressing or holding the fire and thereby prevent from further spreading is described. The method includes the steps of providing a fire suppression device, the device is configured to produce fire-retardant foam; autonomously activating the device upon detection of excessive fire, smoke, or temperature; autonomously forming fire-retardant foam using an aerator by mixing a store of foam concentrate, a store of water, and a store of air; and, releasing fire-retardant foam to cover a structure such as a building, room, or area, to prevent fire from spreading.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a standalone view of one potential embodiment of a fire suppression device of the present invention in accordance with the disclosed architecture;

FIG. 2 illustrates a top-front perspective view of the fire suppression device of the present invention with an open door and lid in accordance with the disclosed architecture;

FIG. 3 illustrates a front perspective view of the fire suppression device of the present invention in accordance with the disclosed architecture;

FIG. 4 illustrates a functional block diagram showing the process of forming fire-retardant foam using the fire suppression device of the present invention in accordance with the disclosed architecture;

FIG. 5 illustrates a flow diagram depicting a process of suppressing fire using the autonomous fire extinguishing device of the present invention in accordance with the disclosed architecture;

FIG. 6 illustrates a flow diagram depicting a process of manual operation of the fire extinguishing device of the present invention in accordance with the disclosed architecture;

FIG. 7 illustrates a perspective view of the fire suppression device of the present invention showing the chambers and components stored in the housing in accordance with the disclosed architecture;

FIG. 8 illustrates a perspective view showing the fire suppression device installed outside a home for covering the home building, or particular areas, with fire-retardant foam in accordance with the disclosed architecture;

FIG. 9 illustrates a perspective view showing the fire suppression device installed outside a home for covering the home building, or particular areas, with fire-retardant foam in accordance with the disclosed architecture, where the fire retardant foam is released at least along a ridge of a roof of the structure; and

FIG. 10 illustrates an exemplary embodiment of a pipe disposed on a structure for release of fire retardant foam therefrom.

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

As noted above, there is a long-felt need in the art for a device that enables a homeowner to protect their home or designated areas from fire. There is also a long-felt need in the art for an improved fire extinguishing device that can be used instead of conventional fire extinguishers. Additionally, there is a long-felt need in the art for a fire suppression device that does not require a user to manually activate and operate the device for extinguishing fire. Moreover, there is a long-felt need in the art for a fire suppression device that autonomously protects a home or room/area from catching on fire. Further, there is a long-felt need in the art for a fire suppression device that reduces losses caused due to house, building, structure fires. Finally, there is a long-felt need in the art for a fire suppression device that autonomously prevents fire in the areas around, or in, a home and does not require physical presence of a user for operating the device.

The present invention, in one exemplary embodiment, is a method of suppressing fire to hold fire and prevent the same from further spreading is described. The method includes the steps of providing a fire suppression device, the device is configured to produce fire-retardant foam; autonomously activating the device upon detection of excessive fire, smoke, or temperature; autonomously forming fire-retardant foam using an aerator by mixing foam concentrate, water, and a gas, such as air, or an inert gas, such as nitrogen; and, releasing fire-retardant foam to cover a structure such as a building, or portions thereof, to prevent fire from spreading.

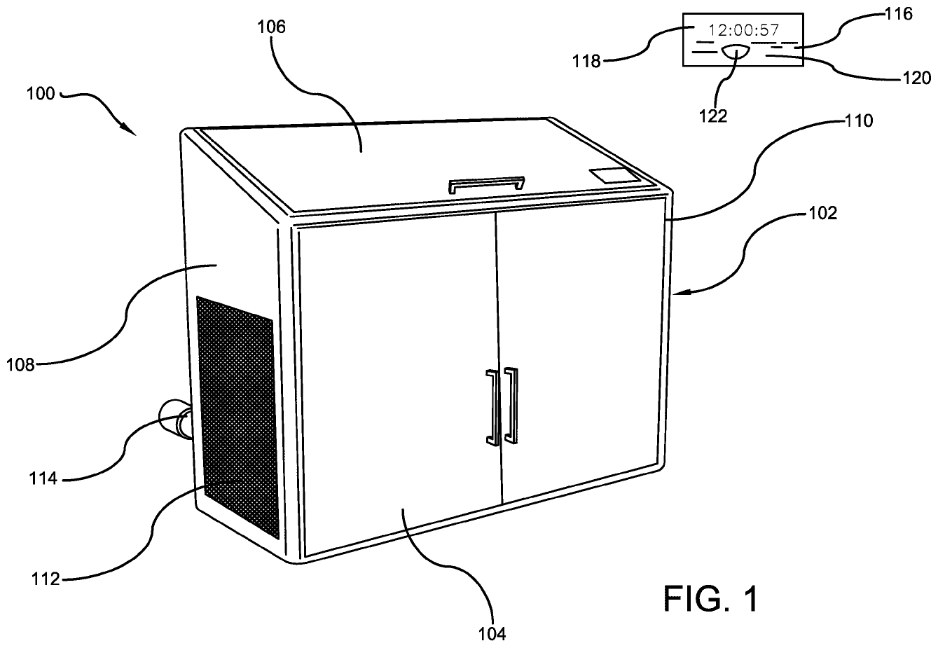

Referring initially to the drawings, FIG. 1 illustrates a standalone view of one potential embodiment of a fire suppression device of the present invention in accordance with the disclosed architecture. The fire suppression device 100 of the present invention is a portable device that can be installed on a roof or around a home or building for providing a fire-retardant foam for preventing/prohibiting the home or building from catching on fire. The device 100 has a housing 102 for storing the necessary components required for generating fire-retardant foam as described later in the disclosure. A front door 104 and a top lid 106 enables a homeowner or an operator to access the stored components therein, wherein the door 104 and the lid 106 also creates a weatherproof structure.

Each of the side walls 108, 110 of the housing 102 has a metal grid 112 for enabling a homeowner to look inside the housing 102 to view a status of the components to prevent any leakage or any other malfunction. For releasing fire-retardant foam, a pipe or discharge opening 114 extends out from the rear wall 114 of the housing 102 wherein the fire-retardant foam is autonomously released by the device 100 upon detecting a high temperature, flame, or smoke. The housing 102 can be made of any lightweight metal, alloy, or heavy-duty plastic for a durable and weatherproof structure.

The lid 106 has a display 116 for displaying current time 118, temperature 120 detected by the device 100, and status 122 indicating working status or malfunction of the fire-retardant foam. The device 100 includes a plurality of sensors for detecting flame, smoke, and temperature as described later in the disclosure. The sensors may communicate with the device 100 with a wired or wireless connection. For example, the sensors may be placed within a building, while the device 100 is positioned at the exterior of the building. The device 100 may be configured to provide fire suppression foam within a building or at an exterior thereof.

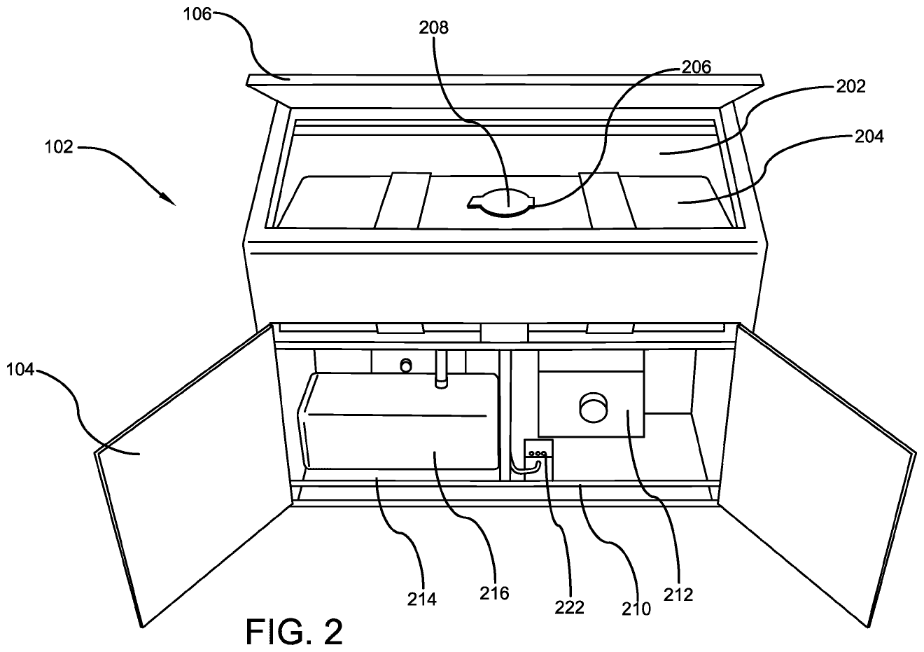

FIG. 2 illustrates a front perspective view of the fire suppression device of the present invention with open door and lid in accordance with the disclosed architecture. The housing 102 includes an upper chamber 202 in which a distilled water reservoir 204 is positioned. The water reservoir 204 stores water, such as distilled water, used for forming fire-retardant foam and has an opening 206 covered by a circular lid 208. The water reservoir 204, in the preferred embodiment, can store up to ten liters of water. The water reservoir 204 can be a single reservoir or can be a combination of two small reservoirs based on design of the fire suppression device 100. In some embodiments, the water reservoir(s) may include water for creating the fire suppression foam as well as a reserve of water to provide a rinsing with only water. In some embodiments, the reservoir(s) may be connected to a water supply, such as a municipal water supply or a body of water from which the reservoirs may be automatically filled. In some embodiments, where a source of water is present, the reservoir(s) may not be required.

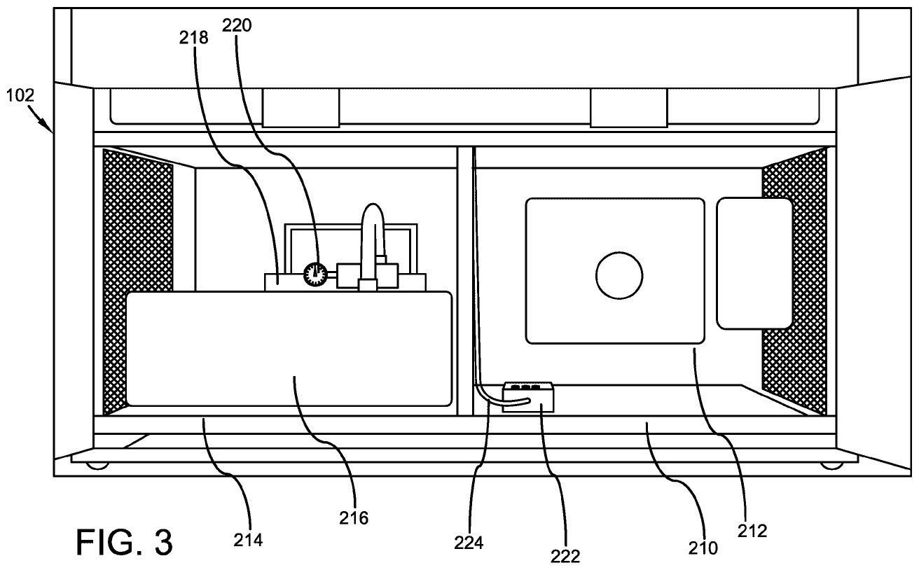

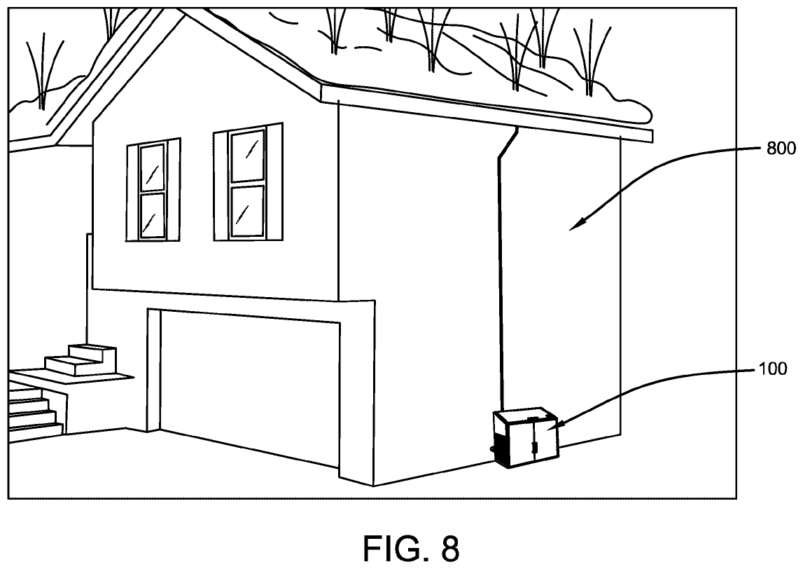

The housing 102 also has a first lower chamber 210 for storing foam concentrate in a foam concentrate reservoir 212. The foam concentrate in the preferred embodiment includes hydrocarbon-based surfactants such as sodium alkyl sulfate, and fluorosurfactants, such as fluorotelomers, perfluorooctanoic acid (PFOA), or perfluorooctanesulfonic acid (PFOS). A second lower chamber 214 includes an air storage 216 for storing air used for making fire-retardant foam. In some embodiments, the air storage 216 may be optional or may be open to atmospheric air. In some embodiments, the opening of the air storage 216 to atmospheric air may include a filter to remove particulates therefrom, before the air is used to generate fire suppression foam. An aeration motor 218 is positioned in the second lower chamber 214 for mixing and aerating the water, foam concentrate, and air in a pressurized manner for creating the fire-retardant foam as illustrated in front view of the device 100 in FIG. 3. The foam is configured to be released from the pipe or discharge opening 114 for covering and surrounding the building, or portion thereof, for preventing same from catching fire. In some embodiments, as shown in FIG. 8, the foam may be disposed at a roof of a structure. This may be performed, for example, along ridges of a roof structure.

Based on use and position of the fire-retardant device 100, aeration pressure can be set by a user using pressure meter 220 of the aeration motor 218. Further, for detecting smoke, flame, or high temperature, a multi-purpose safety sensor 222 is positioned in the housing 102 for autonomously detecting a threshold amount of smoke, flame, or temperature. The sensor 222 upon detecting the threshold amount, autonomously activates the device 100 for producing fire-retardant foam as described above.

It should be noted that in some embodiments of the present invention, a push or touch button may be positioned on an appropriate location on the housing 102 for manually activating the device 100 to produce and release fire-retardant foam. The internal components such as the water reservoir 204, foam concentrate reservoir 212, air storage 216, aeration motor 218, and safety sensor 222 of the device 100 are internally connected via electric circuits 224 and other media for autonomously producing foam for release through the pipe or discharge opening 114. The chambers 202, 210, 214 can be integrated or releasably positioned inside the housing 102 and enables a user to access the respective components in order to replace or replenish the stored items.

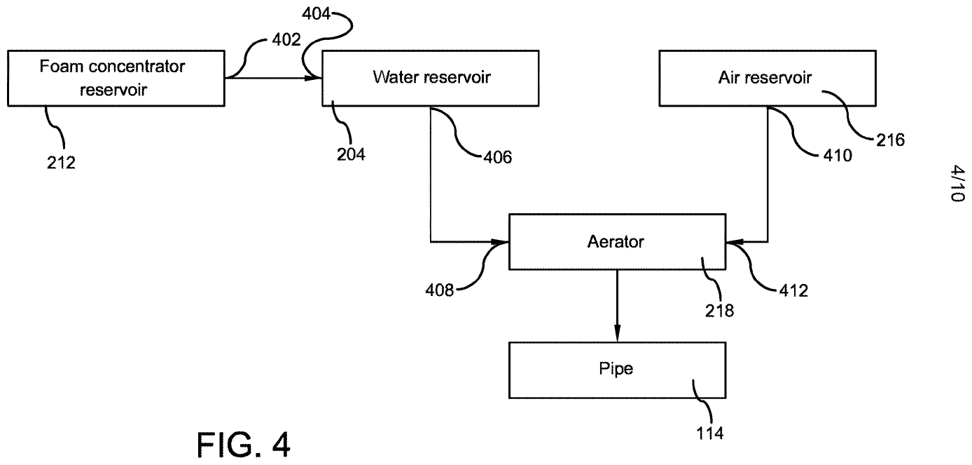

FIG. 4 illustrates a functional block diagram showing the process of forming fire-retardant foam using the fire suppression device of the present invention in accordance with the disclosed architecture. The foam concentrate is released from the outlet 402 of the foam concentrate reservoir 212 towards the inlet 404 of the water reservoir 204 to mix with the water. The mixed water from the outlet 406 moves to the aerator 218 along with air from the reservoir 216 moving from the respective outlet 410 to the inlet 412 of the aerator.

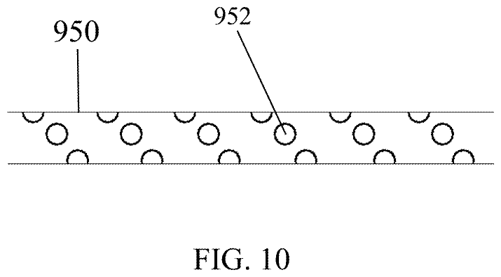

The aerator 218 is configured to perform aeration of the foam concentrate and water to form fire-retardant foam. The fire-retardant foam is then released through the pipe or discharge opening 114 for release in the surrounding area to suppress fire and smoke. The discharge opening 114 can fluidly communicate with a pipe that is configured to release the foam on the structure. For example, the pipe 950 of FIG. 10 may be used, where multiple outlets 952 are formed in different directions along the length of the pipe. While FIG. 10 illustrates a certain pattering of outlets 952, the number of outlets 952, the angles thereof (directing a direction of flow of the fire retardant foam) and the size thereof (controlling, for example, a distance of the flow of the fire retardant foam from the pipe 950) can vary, depending on the application. The outlets 952 may be openings in the pipe 950 or may be specially designed nozzles for distributing the foam out of the pipe 950.

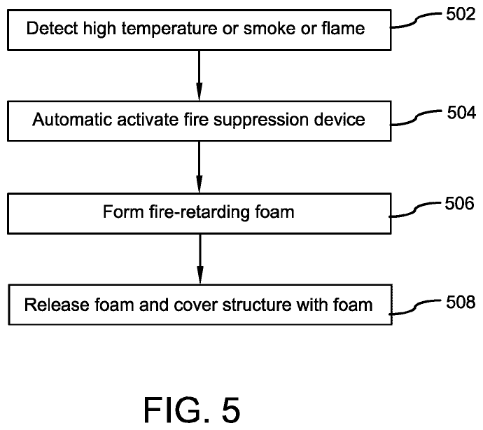

FIG. 5 illustrates a flow diagram depicting a process of suppressing fire using the autonomous fire extinguishing device of the present invention in accordance with the disclosed architecture. Initially, the multi-purpose sensor of the device detects a high temperature, fire, or smoke in and around a building or designated area (Step 502). The device can be kept on a roof or on the ground for easy detection of the fire and smoke. As described above, the detection of fire and smoke may be made at the location of the device 100, or may be performed by a remote sensor that communicates with the device 100. Upon detection of a threshold temperature, smoke, or fire, the device 100 is autonomously activated or actuated, wherein all the components and flow of foam concentrate and air is performed (Step 504). Then, the aerator is activated upon receiving water, foam concentrate, and air to form fire-retardant foam under high pressure (Step 506). Finally, the foam is released from the pipe to cover the surrounding structure with foam to suppress the fire for easy prevention of catastrophic damage to the home (Step 508).

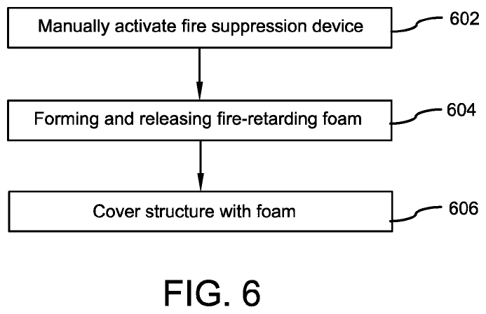

FIG. 6 illustrates a flow diagram depicting a process of manual operation of the fire extinguishing device of the present invention in accordance with the disclosed architecture. Initially, using the push or touch button, the fire suppression device is manually activated by a user such as a homeowner (Step 602). Upon manual activation, the device starts functioning to form fire-retardant foam in an automated manner (Step 604). The formed foam is also released in the surroundings of the device for creating a fire-retardant cover for suppressing and prohibiting fire. The foam is created and released with high pressure using the aerator such that a building or any other structure (or portions thereof) is covered with foam for suppressing the existing fire and for preventing flow of oxygen to feed the fire (Step 606).

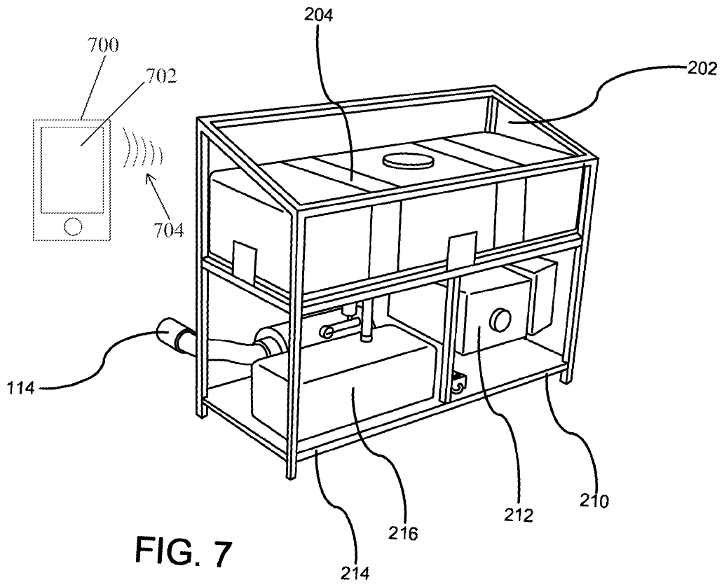

FIG. 7 illustrates a perspective view of the fire suppression device of the present invention showing the chambers and components stored in the housing in accordance with the disclosed architecture. As illustrated, the housing 102 is integrated as one unit comprising of a plurality of chambers for storing a plurality of components as also described above in the disclosure. The housing 102 can be designed in a variety of designs with different materials including, but not limited to iron, aluminum, steel, plastic, and more. The components; water reservoir 204, foam concentrate reservoir 212, air storage 216, aeration motor 218, and safety sensor 222 can be individually accessed and removed as per preferences of a user.

In some embodiments, an electronic device, such as a mobile phone 700 may communicate with a wireless communication signal 704 with the device. The phone 700 may include a graphical user interface (GUI) 702 that can provide the user with status information and control of the device. For example, the user, via the GUI 702 may activate the device, may see the fill level of water or foam concentrate in the device, may de-active the device, or the like. The phone 700 may also receive notifications, such as a push notification or an SMS text, for example, that can alert the user to the activation or potential activation of the device. In some embodiments, the user may require input to actually activate the device, where such input may be provided via the phone 700. In other embodiments, the device may activate automatically and send a notification to inform the user. The GUI 702 may provide other information to the user, such as weather information, fire alert information (such as red flag warnings, or the like), system status, or the like. The GUI 702 may also provide user adjustable selections, such as time of deployment, automatic or manual activation and the like. The GUI 702 may also provide the user to release rinse water through the device in order to rinse out the pipes and to help wash the foam off the structure once the fire threat is eliminated. Further, either the device directly, or the phone 700, after being alerted by the device, may contact first responders to advice of the activation of the fire suppression device.

The device itself, the phone 700, or both, may provide a user with a warning before and/or during activation of the device. The warning may be, for example, a pulse warning buzzer space sound. The warning may be activated outside and/or inside the structure.

The placement of different components inside the housing 102 can vary and when the housing 102 is covered by a metal body, the components become weatherproof and can be positioned in any outdoor location.

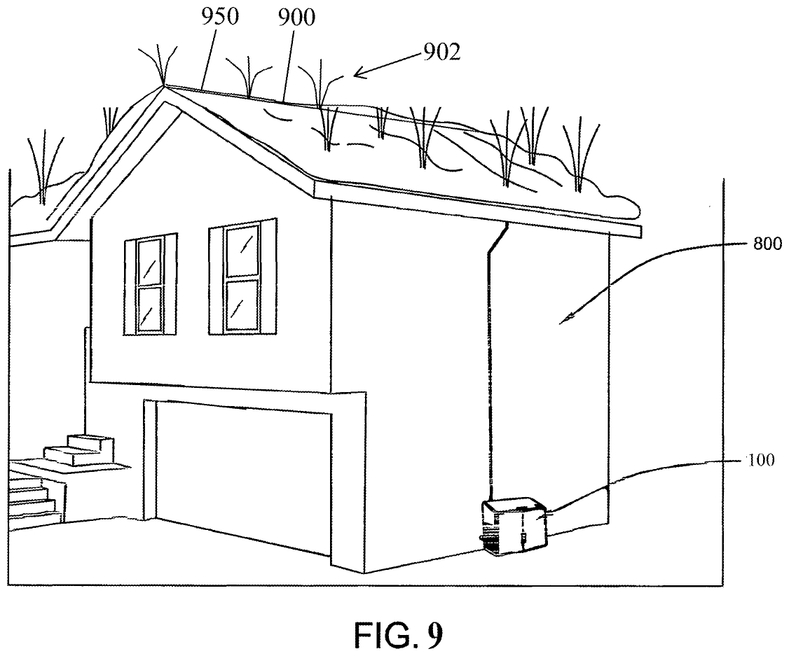

FIG. 8 illustrates a perspective view showing the fire suppression device installed outside a home for covering the home building with fire-retardant foam in accordance with the disclosed architecture. As illustrated, the device 100 is installed outside the home building 800 such that the multi-purpose sensor of the device 100 detects fire, smoke, or high temperature indicating a potential fire such that the device 100 autonomously creates and releases fire-retardant foam to cover the building 800, or portions thereof. As shown in FIG. 9, the release of fire-retardant form 902 may be at the ridge 900 of the structure. Of course, the position of the releases of the foam can vary, depending on the particular application.

The device 100 can be installed with newly built buildings or can be coupled (i.e., retrofitted) to existing buildings. Further, the capacity of the device 100 can be adjusted to meet requirements of covering buildings of different sizes, structures, designated areas, rooms, fireplaces, cooking areas, and the like. In different embodiments of the present invention, the device 100 can produce Class A foam and/or Class B foam. Class A foams can be specifically used for controlling wildfires and structure fires. Class B foams are used for flammable liquids and can be protein foams or synthetic foams.

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “fire extinguishing device”, “autonomous fire extinguishing device”, “fire suppression device”, and “device” are interchangeable and refer to the autonomous fire suppression device 100 of the present invention.

Notwithstanding the forgoing, the autonomous fire suppression device 100 of the present invention can be of any suitable size and configuration as is known in the art without affecting the overall concept of the invention, provided that it accomplishes the above stated objectives. One of ordinary skill in the art will appreciate that the autonomous fire suppression device 100 as shown in the FIGS. are for illustrative purposes only, and that many other sizes and shapes of the autonomous fire suppression device 100 are well within the scope of the present disclosure. Although the dimensions of the autonomous fire suppression device 100 are important design parameters for user convenience, the autonomous fire suppression device 100 may be of any size that ensures optimal performance during use and/or that suits the user's needs and/or preferences.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

1. A fire suppression device for suppressing a fire, the fire suppression device comprising:
a water source for the fire suppression device;
a foam concentrate reservoir, wherein said foam concentrate reservoir comprises a quantity of foam concentrate;
an air chamber comprised of a quantity of air;
an aeration motor configured to mix and aerate water from the water source, a quantity of foam concentrate and a quantity of air to create a fire-retardant foam;
a discharge opening for delivering the fire-retardant foam to a desired location; and
a plurality of sensors operable to sense evidence of a fire condition,
wherein the fire suppression device automatically activates when the plurality of sensors sense evidence of the fire condition to cause fire-retardant foam to exit the discharge opening and cover at least a portion of an exterior roof surface of a structure; and
wherein the fire suppression device is disposed at a fixed location at the exterior of the structure.

2. The fire suppression device of claim 1, further comprising:
a water reservoir as the water source, wherein said water reservoir is in a first chamber and comprises a quantity of water;
a second chamber for the foam concentrate reservoir; and
a housing comprising a first opening for accessing the first chamber and a second opening for accessing the second chamber.

3. The fire suppression device of claim 1, wherein said aerating is in a pressurized manner for creating said fire-retardant foam.

4. The fire suppression device of claim 1, wherein said discharged said fire-retardant foam covers a fire at the desired location.

5. The fire suppression device of claim 4, wherein the covering the fire comprises covering at least a portion of a structure.

6. The fire suppression device of claim 1, wherein said plurality of sensors is at least two sensors selected from a group of sensors consisting of a temperature sensor, a flame sensor, and a smoke detector.

7. The fire suppression device of claim 1, wherein said distilled water is provided as the water source.

8. The fire suppression device of claim 1, further comprising a display for displaying a current temperature and a status indicator.

9. The fire suppression device of claim 1, wherein said foam concentrate reservoir is a vacuum storage reservoir.

10. The fire suppression device of claim 1, wherein said foam concentrate reservoir is a storage of one or more chemicals selected from a group consisting of a hydrocarbon-based surfactant, a sodium alkyl sulfate, a fluorosurfactant, a fluorotelomer, a perfluorooctanoic acid (PFOA) and a perfluorooctanesulfonic acid (PFOS).

11. The fire suppression device of claim 1, further comprising an alert mechanism, the alert mechanism providing an alert to at least one of a mobile phone, a first responder, or a pulse warning buzzer.

12. The fire suppression device of claim 1, further comprising a wireless signal transceiver operable to send and/or receive a wireless signal from a remote electronic device.

13. A fire suppression device for suppressing a fire, the fire suppression device comprising:
a housing;
a water reservoir;
a foam concentrate reservoir;
an air storage;
an aeration motor; and
a discharge opening;
wherein said housing has a first opening for accessing a first chamber and a second opening for accessing a second chamber, and a third chamber;
wherein said water reservoir is in said first chamber and includes a store of water;
wherein said foam concentrate reservoir is in said second chamber and includes a store of foam concentrate;
wherein said air storage is disposed in the third chamber and includes a store of air;
wherein said third chamber has said aeration motor for mixing and aerating said water, said foam concentrate, and said air for creating a fire-retardant foam; and
wherein said housing having a touch button for manually activating said fire suppression device to produce and release said fire-retardant foam,
wherein the fire suppression device automatically activates when a plurality of sensors sense evidence of the fire condition to cause fire-retardant foam to exit the discharge opening and cover at least a portion of an exterior roof surface of a structure; and
wherein the fire suppression device is disposed at a fixed location at the exterior of the structure.

14. The fire suppression device of claim 13, wherein said first chamber, said second chamber, and said third chamber are integrated inside said housing.

15. The fire suppression device of claim 14, wherein said water reservoir, said foam concentrate reservoir, said air storage, and said aeration motor are internally connected via electric circuits to autonomously said mixing and said aerating said water, said foam concentrate, and said air for creating said fire-retardant foam and for discharging said fire-retardant foam from said discharge opening.

16. The fire suppression device of claim 15, wherein said aerating is in a pressurized manner for creating said fire-retardant foam.

17. The fire suppression device of claim 15 further comprising a sensor, wherein said fire-retardant foam is discharged from said discharge opening when said sensor detects a threshold amount.

18. The fire suppression device of claim 17 wherein said sensor is selected from a group of sensors consisting of a temperature sensor, a flame sensor, and a smoke detector.

19. A method of suppressing a fire comprising the steps of:
forming a fire suppression device having a housing including a water reservoir, a foam concentrate reservoir, an air storage, an aeration motor, a discharge opening, and a sensor;
wherein said housing has a first opening for accessing a first chamber and a second opening for accessing a second chamber;
wherein said water reservoir is in said first chamber and includes a store of water;
wherein said foam concentrate reservoir is in said second chamber and includes a store of foam concentrate;
wherein said air storage having a third chamber and includes a store of air;
actuating a mixing of said water, said foam concentrate, and said air when said sensor detects a threshold amount;
aerating said water, said foam concentrate, and said air for creating a fire-retardant foam; and
discharging said fire-retardant foam from said discharge opening, when a plurality of sensors sense evidence of a fire condition, to cover at least a portion of an exterior roof surface of a structure,
wherein the fire suppression device is disposed at a fixed location at the exterior of the structure.

20. The method of suppressing a fire of claim 19, wherein said foam concentrate is one or more chemicals selected from a group consisting of a hydrocarbon-based surfactant, a sodium alkyl sulfate, a fluorosurfactant, a fluorotelomer, a perfluorooctanoic acid (PFOA), and a perfluorooctanesulfonic acid (PFOS).
